(19) United States
(12) Patent Application Publication
(10) Pub. No.: US 2006/0171571 A1
(43) Pub. Date: Aug. 3, 2006

(54) Systems and methods for quality-based fusion of multiple biometrics for authentication

(76) Inventors: Michael T. Chan, Niskayuna, NY (US); Rebecca E.B. Brown, Clifton Park, NY (US); Wesley Turner, Rexford, NY (US); Timothy P. Kelliher, Scotia, NY (US); Ronald D. Sutton, Orlando, FL (US); Mark K. Cavanagh, Orlando, FL (US)

Correspondence Address: WELSH & KATZ, LTD, 120 S RIVERSIDE PLAZA, 22ND FLOOR, CHICAGO, IL, 60606, US

(21) Appl. No.: 11/205,515

(22) Filed: Aug. 17, 2005

Related U.S. Application Data
(60) Provisional application No. 60/648,826, filed on Feb. 1, 2005.

(51) Int. Cl. G06K 9/00

(52) U.S. Cl. 382/115

(57) ABSTRACT

An authentication system incorporates pluralilty of fused biometric modalities which are combined with quality indicia of the biometric samples. Fusion processing maps individual modality data along with one or more quality measurements to a fused score for purposes of making an authentication decision.

### CROSS REFERENCE TO RELATED APPLICATION

This application claims the benefit of the filing date of U.S. Provisional Application Ser. No. 60/648,826 filed Feb. 1, 2005 and entitled “Methods for Fusing Multiple Biometrics for Authentication”.

### FIELD OF THE INVENTION

The invention pertains to systems and methods of authenticating individuals. More particularly, the invention pertains to such systems and methods which incorporate at least one biometric measurement relative to an individual as well as at least one quality measurement relative thereto.

### BACKGROUND OF THE INVENTION

It has been recognized that the performance of authentication systems can be improved by making use of multiple biometric measurements. For example, fingerprints and facial images can be used in combination to improve performance. It has also been recognized that acoustic and visual features can be combined for the same purposes. Prior results indicate in general that systems which incorporate multiple modalities in the authentication algorithm, biometric fusion, can be expected to outperform those that rely on only a single modality. For example, known fusion processing has been described by Ross and Jain in “Information Fusion in Biometric:, Pattern Recognition Letters Vol. 24 pgs 2115-2125 September 2003.

One prior art process, is the matching-score level fusion process. If S_{A} and S_{B} are the match scores returned by two biometric matching algorithms on two biometric samples, the fused score is given by
S_{AB}=W_{A}×f(S_{A})+W_{B}×f(S_{B}),
where W_{A} and W_{B} are the corresponding weights applied to the two modalities and f represents any score transformation or normalization scheme. With proper score normalization, the sum fusion rule has been found to be quite effective.

Notwithstanding the known systems, there continues to be a need for improved authentication systems with improved performance relative to known systems. Preferably, such improved systems would still be able to receive as inputs, data relating to regularly measured biometric factors such as fingerprints, facial images, iris, acoustic data, palm prints or hand geometry in various combinations so as to take advantage of existing equipment and processes for obtaining such biometric data. Further, it would be preferable if such improved systems could outperform known systems based on multiple modalities while at the same time provide shorter decisional processing time intervals.

Finally, known systems do not take into account quality characteristics of received biometric data. It would be desirable to incorporate a measure of data quality.

### BRIEF DESCRIPTION OF THE DRAWINGS

FIG. 1 is a flow diagram of a process in accordance with the invention for development of an evaluation rule(s);

FIG. 2 is a flow diagram of a process in accordance with the invention of using the evaluation rule of FIG. 1;

FIG. 3 is a block diagram of a system in accordance with the invention; and

FIGS. 4-10, taken together, illustrate exemplary processing in accordance with the invention; and

FIG. 11 is a flow diagram of a two biometric process that takes into account quality characteristics.

### DETAILED DESCRIPTION OF THE EMBODIMENTS

While embodiments of this invention can take many different forms, specific embodiments thereof are shown in the drawings and will be described herein in detail with the understanding that the present disclosure is to be considered as an exemplification of the principles of the invention and is not intended to limit the invention to the specific embodiment illustrated.

Biometric fusion refers to a combination of biometric data to improve matching accuracy. Matching accuracy can be expressed in terms of False Match Rate and False Non-Match Rate.

Fusion in accordance with the invention can combine biometric data from different biometric modalities, such as fingerprints, iris scans, retinal scans or facial images which can be evaluated with modality-specific matching algorithms. Alternately, multiple samples from a single modality can be evaluated with one or more matching algorithms (such as multiple facial images), or one sample from a single modality can be evaluated with multiple algorithms (such as a single fingerprint evaluated with several matching algorithms). The fusion techniques described herein can be applied to all of these approaches, as well as to combinations thereof. Thus, more effective matching algorithms or processes can be combined, for a selected biometric, with quality indicia.

A method which embodies the invention incorporates biometric quality metrics to implement fusion rules that achieve results superior to known, previously described, biometric fusion approaches. The resulting fusion rule can also account for the relative strength of the biometric algorithms used, thus making it useful for multi-modal systems in which quality metrics are not applied. The quality metrics associated with respective biometric samples can be used to dynamically adjust the fusion parameters.

In yet another aspect of the invention, match scores and predictive quality metrics jointly determine the fused score. Thus, a process which embodies the invention can take into account both the relative discriminative capabilities of the biometrics being fused and the respective sample qualities.

This process can be applied without limitation to any biometric algorithm or modality for which a predictive quality metric can be identified. Such a quality metric has the property of predicting the matching accuracy that can be obtained when using a biometric sample with a given quality score. A predictive quality metric is one that produces a higher quality score for a biometric sample that results in a higher match score when compared to a true mate (i.e., another biometric sample from the same individual), and a lower quality score for a biometric sample that results in a low match score again when compared to a true mate

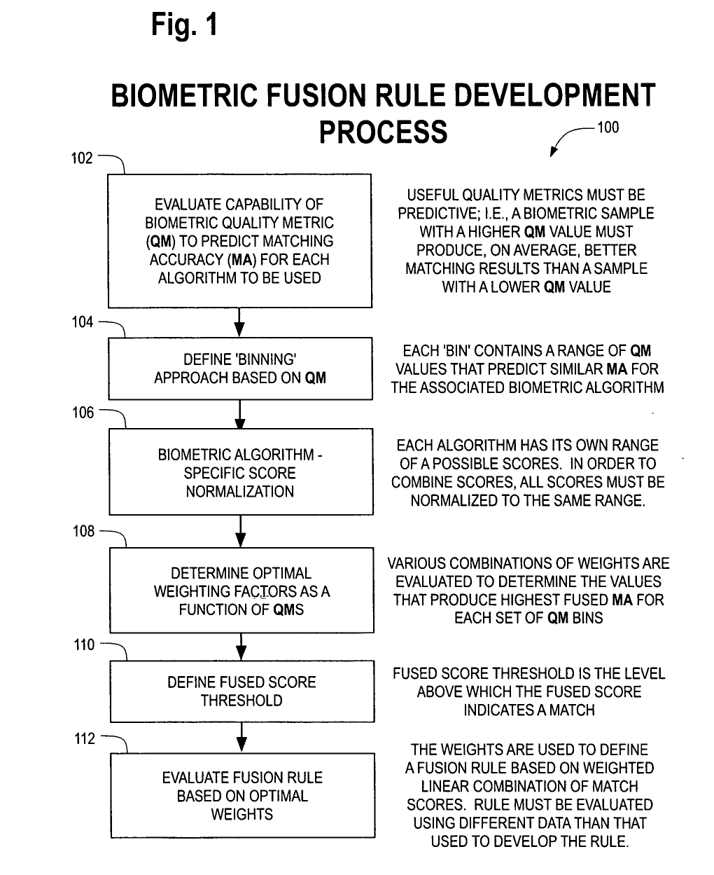

The process includes a series of steps that are depicted in FIG. 1, in method 100, “Biometric Fusion Rule Development Process”. The following paragraphs explain the steps involved.

Step 102 involves evaluation of the predictive properties of the proposed quality metric. In this step, a statistically representative set of biometric samples from each modality to be used in the system is evaluated using the quality metric, and these samples are compared to one another to produce matching scores. The data set preferably will include multiple biometric samples from each individual represented in the set so that scores for both true mates and non-mates can be obtained. The correlation of high quality metric scores with high true mate matching scores, as well as low quality metric scores with low true mate matching scores, is evaluated to verify the predictive capability of the metric. If strong correlation is not found to exist, the quality metric may not be suitable for use in this process.

In step 104 quality scores are ‘binned’. Binning involves separating the range of possible quality metric scores into a smaller number of contiguous ranges that exhibit similar matching accuracy characteristics. Any number of bins can be used, depending on the mathematical behavior of the quality metric and the degree of accuracy desired. If desired, as an alternate to a finite number of bins, with an associated look-up table, an infinite number of bins (a continuous quality metric) can be used with a selected function instead of the look-up table.

In step 106, in FIG. 1, an approach is developed to normalize the scores produced by the biometric matching algorithms to be used in the system. This step is desirable because one algorithm might produce a range of matching scores that varies between a minimum of 0 and a maximum of 100, while another might range between 1 and 10. Since the fusion rule(s) produced by this process is/are a weighted linear combination of matching scores, the scores preferably will be adjusted to share a common range.

In step 108, in FIG. 1, the optimal weighting factors are determined. This can be done in a variety of ways, including exhaustive evaluation of the fusion rules resulting from various combinations of weights. A separate set of optimal weights is determined for each possible combination of biometric sample quality metrics (as quantized in the binning process).

In step 110, a Fused Score Threshold is defined. This is the value above which the fused score indicates a biometric match. This threshold can be the sum of the normalized thresholds for the biometric algorithms used in the system, or determined based on the desired level of True and False accept rates

In step 112, the fusion rule is evaluated against a new dataset that does not include any of the data used to develop the rule. The rule can be represented by the linear equation
FS=Ax+By+ . . . +Zβ
where A, B, . . . , Z are weights, and x, y, . . . , β are the corresponding matching scores. The success of the process can be evaluated by comparing the Receiver Operating Characteristics curve produced through use of the quality metric-based fusion rule against the Sum of Scores approach described by Jain and Ross in “Information Fusion in Biometrics”, cited above.

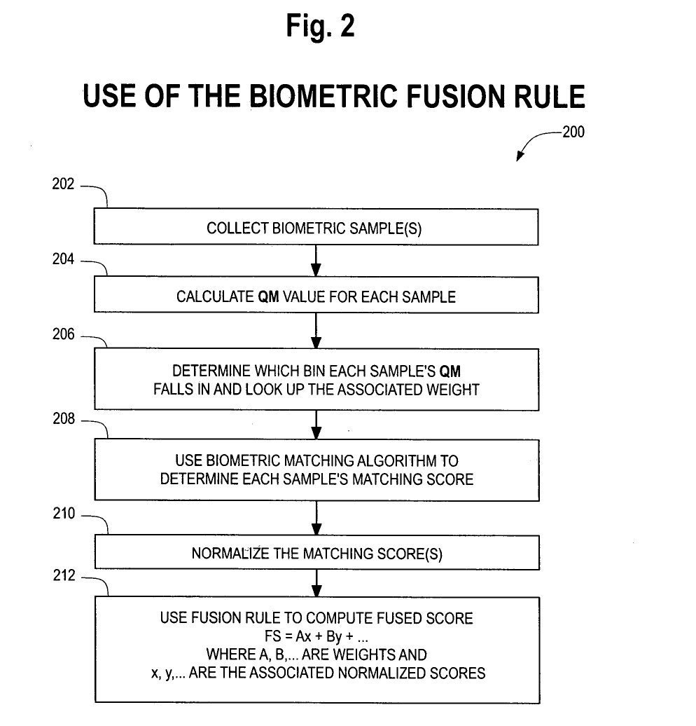

FIG. 2 depicts the steps of method 200 involved in using the quality-based biometric fusion rule in an authentication system. An initial step 202 is to collect the biometric sample(s) to be used in making a match/no match decision. Next, step 204, the quality metric associated with the matching algorithm(s) used is computed for each sample. The corresponding bin is then determined, step 206, and the associated weight is determined or looked up. The matching scores are computed, step 208 and normalized step 210. The Fused Score is computed, step 212, and compared against the Fused Score Threshold, to make an accept or reject decision.

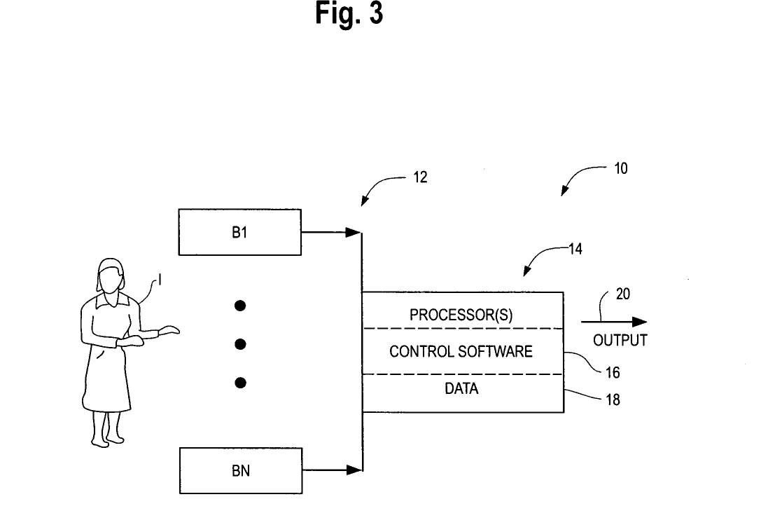

FIG. 3 is a block diagram of a system 10 which embodies the present invention. System 10 includes one or more biometric data acquisition devices/systems B1, B2, Bn for sensing and initially processing biometric information of an individual which can be used for authentication. Representative biometrics include fingerprints, facial images, iris scans, retinal scans, palm prints, ear images and geometry or acoustic data all without limitation.

Representations of sensed biometric information are forwarded to one or more processors indicated generally at 14 for processing, for example, using the biometric fusion methodology of FIG. 2. Control software 16 executed by one or more processors 14, based on received data 18 from the biometric sensors/systems B1 . . . Bn can carry out the exemplary biometric fusion processing 200 of FIG. 2. As a result of that processing, output indicia 20 which could be audible or visual without limitation, can be provided. The output indicia can itself be the basis for carrying out further activities as a result of authentifying or not authentifying the individual of interest. Alternately, the output 20 could be one of many indicia considered by a decision maker.

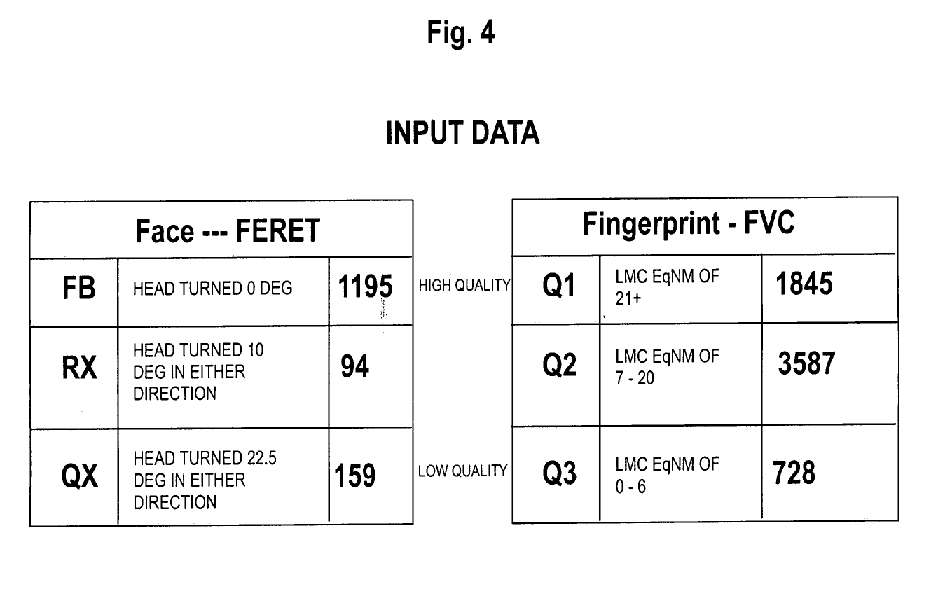

FIGS. 4 through 10, taken together illustrate exemplary processing in accordance with the invention. FIG. 4 illustrates 3 exemplary quality metric bins for each of 2 biometrics. The selected biometrics include a facial image and fingerprint of an individual requesting or seeking authentification. FIG. 4 illustrates the criteria used to place a given biometric sample into a corresponding bin, and the number of samples from exemplary test data that fell into each bin.

Those of skill will understand that the illustrated 3 bins are merely exemplary. Ten or more bins could be used in connection with each biometric to provide optimized results.

Facial biometric samples for evaluation can be based on a publicly available FERET facial database, Phillips et al. the “FERET Evaluation Methodology for Face Recognition Algorithms” IEET Trans., Pattern Analysis and Machine Intelligence, Vol. 22 No. 10, October 2000.

Fingerprint samples can be processed by a known fingerprint matching system such as disclosed in U.S. Pat. No. 5,613,014 assigned to the assignee hereof and incorporated by reference.

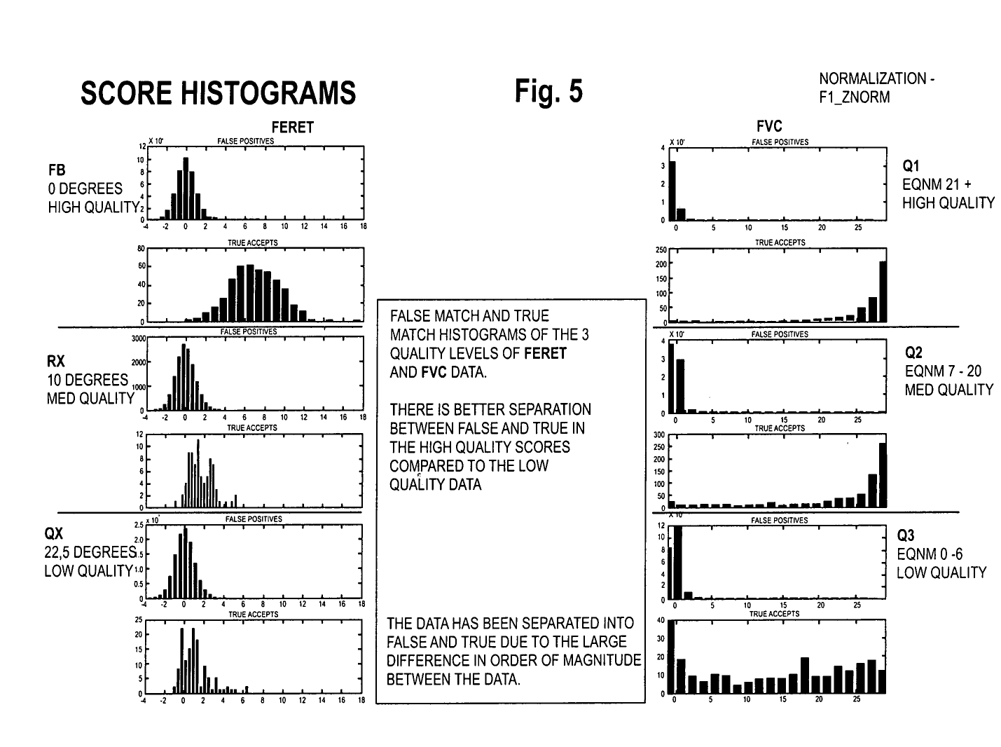

FIG. 5 illustrates the “predictive” characteristic of the quality metric associated with each bin. Increasing horizontal separation between false positives and true accepts for each bin illustrates where greatest accuracy can be expected.

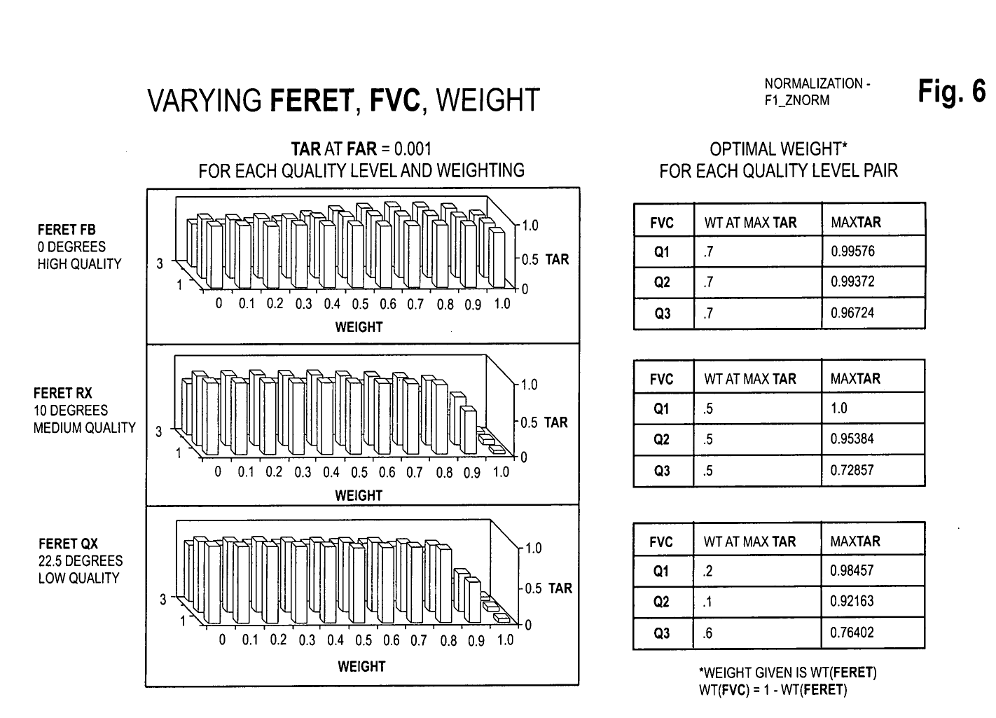

FIG. 6 illustrates how matching accuracy (defined here as TAR at FAR=0.001 as an example) varies by adjusting the fusion weight of each modality as a function of quality characteristics of biometric samples. The fusion weights, to be used in the fusion equation, step 206, were selected where the best results were obtained with a training data set. The tables at the right of FIG. 6 illustrate a different weight for each quality metric quantization that produces the best results.

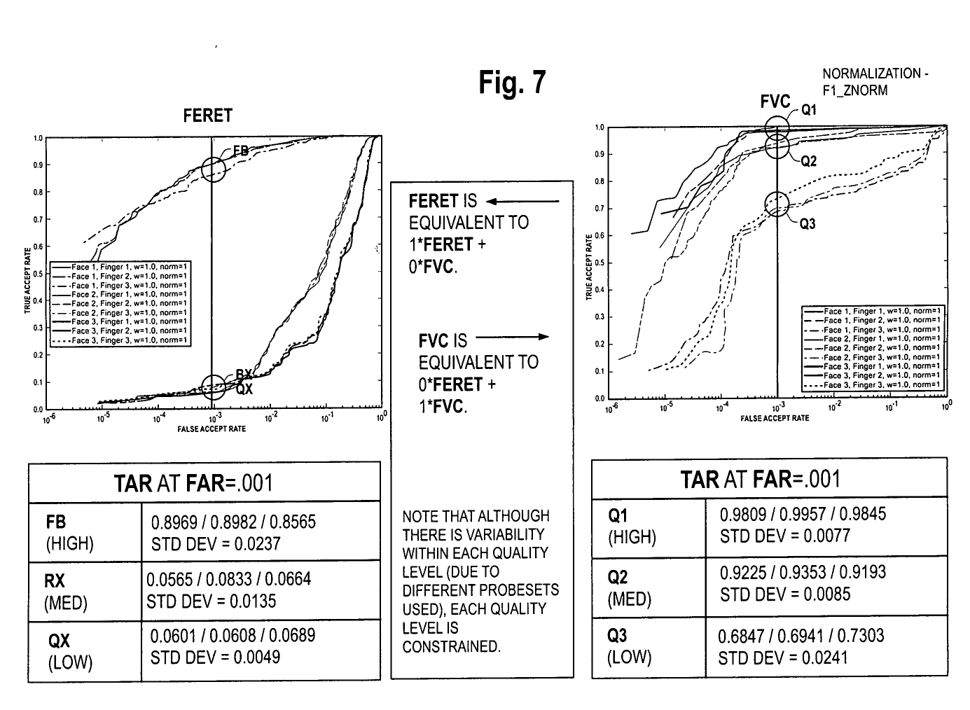

FIG. 7 illustrates that the “true accept rate” for each individual biometric does in fact vary in a manner expected with the quality of the biometric samples. Those of skill will recognize that a lower quality input yields a lower true accept rate.

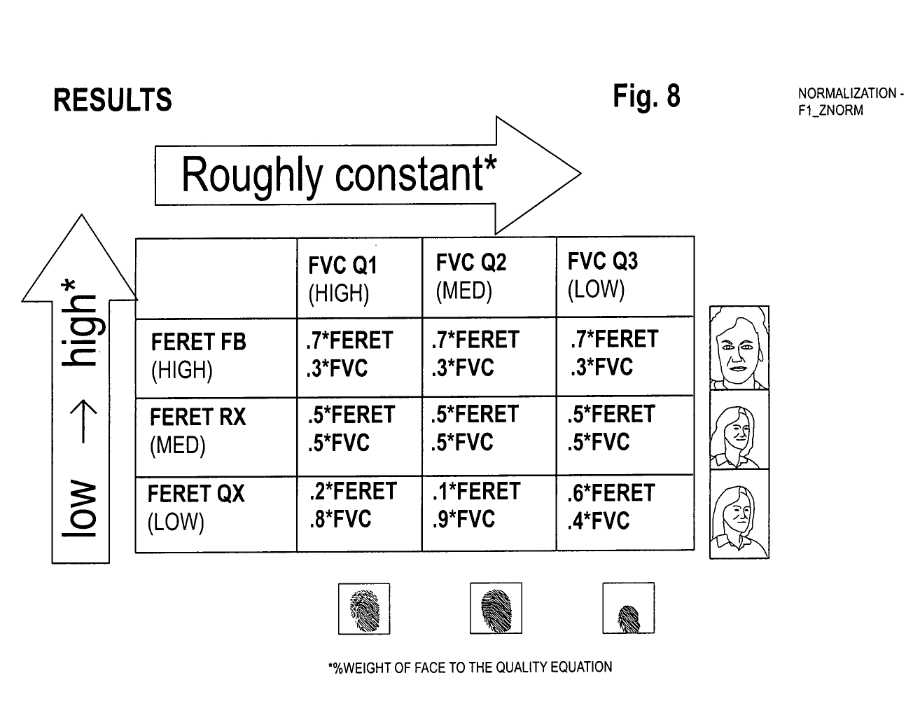

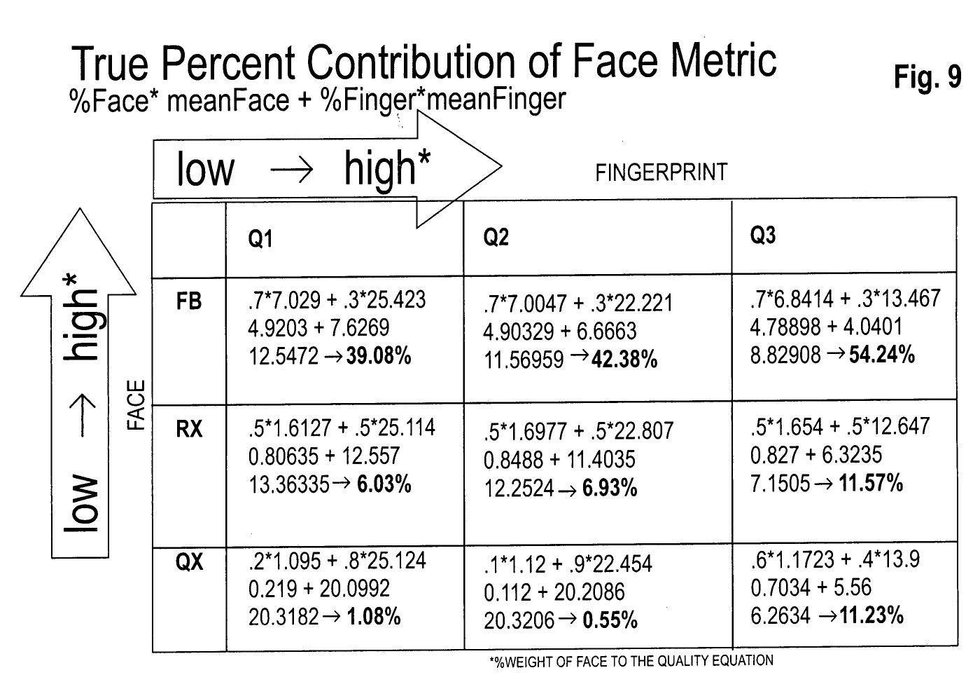

FIG. 8 illustrates weights selected based on processing reflected in FIGS. 4-7, discussed above. FIG. 9 illustrates the actual contribution of each biometric's score of the composite score for each of the nine combinations of biometric quality. As illustrated in FIG. 9, the relative contribution of each modality generally increases with the quality level of samples of that modality based on the chosen quality metrics.

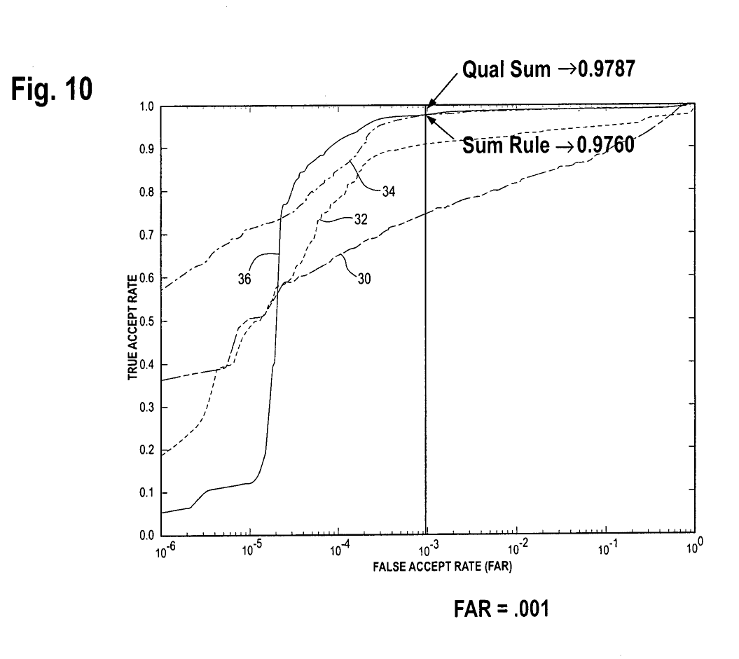

The graph of FIG. 10 compares results of a system and method which embody the invention versus known fusion processing such as described by Ross and Jain in “Information Fusion in Biometric”, cited above.

Graph 30 of FIG. 10 illustrates facial biometric only recognition results. Graph 32 illustrates fingerprint only recognition results. Graph 34 illustrates sum fusion, without quality input, recognition results. Graph 36 illustrates the recognition results achievable with fusion in accordance with the invention which takes into account both sample quality and processed match results. FIG. 10 clearly illustrates the recognition improvement of the process of graph 36. The accuracy gain at lower False Accept Rates is especially noticeable.

It will be understood that variations come within the spirit and scope of the invention. One such includes obtaining a plurality of samples of the same biometric from an individual and processing them in accordance herewith. Another includes obtaining a sample of a biometric identifier and processing that sample using different techniques in accordance herewith.

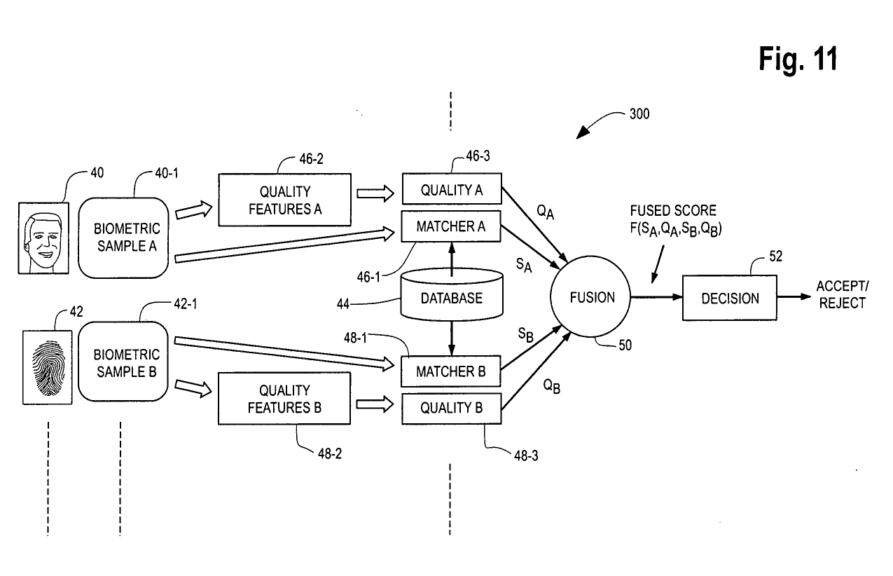

FIG. 11 is a flow diagram of an exemplary process 300 which incorporates two different types of biometric samples. One type of biometric sample is a facial scan 40. A second type of biometric sample is a fingerprint 42.

Scanner 40-1 acquires facial scan biometric information, from sample 40, which can be coupled to or forwarded to a matching process or facial matching algorithm 46-1. Quality characteristics can be extracted from the facial information in a process 46-2.

The output of quality processing 46-2, quality characteristics 46-3, associated with the scanned facial image 40, along with output information from the matching processor 46-1 can be coupled to fusion processing software 50. Fusion processing software 50 can combine matching characteristics and quality parameters, as discussed in more detail subsequently to produce a fused score upon which accept/reject decision processing 52 can be based.

Similarly, sampled fingerprint information 42-1 can be forwarded to fingerprint matching processor 48-1. Quality characteristics associated with the fingerprint information 42-1 can be extracted by quality processor 48-2. Matching processor 48-1 can compare the biometric sample 42-1 to restored fingerprint samples in database 44.

Matching scores from matching processor 48-1 along with the quality information 48-3 are forwarded to fusion processing 50 to produce a fused score. One form of fusion processing can be achieved by software 50 implementing a linear equation such as:
F=W_{A}(Q_{A},Q_{B})*S_{A}+W_{B}(Q_{A},Q_{B})*S_{B}

As indicated above, the fusion processing 50 can take into account relative discriminative capabilities of the biometrics being fused as well as the respective sample qualities. In this regard, S_{A} and S_{B} can be provided as normalized scores from the respective face and finger biometrics 40, 42. Q_{A} and Q_{B} are the quality indicia corresponding to indicia 46-3, 48-3. In a disclosed embodiment, the weight functions for facial biometric and finger biometric information can be related as follows:
W_{A}=1−W_{B}
The case W_{A}=W_{B} corresponds to one known sum fusion rule.

It will be understood that variations on the process 300 come within the spirit and scope of the present invention. For example, additional biometrics can be incorporated in the process 300, such as iris scans, retinal scans, palm scans, and the like all without departing from the spirit and scope and of the invention. Alternately, the information extracted from biometric sample 40 or 42 for example could be subject to several different matching processes in addition to the illustrated matching process 46-1, 48-1. These additional matching scores can also be incorporated into the fusion processing 50. It will also be understood by those of skill in the art that the process 300 illustrated in FIG. 11 could be implemented with a plurality of software modules such as the modules 16, FIG. 3, which could be used to program processor 14.

One of the advantages of systems and methods which embody the invention is that different biometrics and matching processes can be combined within the same processing framework. Further, biometric sensing or scanning equipment based on differing technologies can also be incorporated in the same framework.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed:

1. A method comprising:
establishing at least two different biometric identifiers;
establishing at least one quality indicium, the indicium is associated with one of the identifiers;
obtaining information corresponding to each of the identifiers from an individual;
determining a representation of the quality indicium; and
combining the information with the representation of the quality indicium to form a multiple parameter based authentication indicium.

2. A method as in claim 1 which includes;
making an authentication decision in response to the authentication indicium.

3. A method as in claim 1 which includes establishing at least three different biometric identifiers.

4. A method as in claim 1 which includes establishing at least two different quality indicia, each indicium is associated with a respective biometric identifier.

5. A method as in claim 1 which includes establishing quality-dependent fusion weights so as to maximize authentication accuracy based on performance metrics including True and False accept rates.

6. A method comprising:
establishing at least one biometric identifier;
establishing at least one quality indicium associated with the identifier;
obtaining information corresponding to the identifier from an individual;
establishing a representation of the quality indicium; and
combining the information with the representation to form an authentication indicium.

7. A method as in claim 6 where the obtaining includes obtaining a plurality of biometric samples from an individual.

8. A method as in claim 7 which includes associating the representation with a sample.

9. A method as in claim 6 where the combining includes processing the information for a biometric identifier with a plurality of different methods.

10. A method as in claim 9 where the quality indicium is associated with a selected method.

11. A method as in claim 7 which includes:
making an authentication decision in response to the authentication indicium.

12. A method as in claim 9 which includes:
making an authentication decision in response to the authentication indicium.

13. An apparatus comprising:
first data acquisition software that obtains information associated with a first type of biometric;
software to provide a first biometric quality indicium;
processing software to combine at least part of the information with the first quality indicium to produce a first authentication indicium; and
an output device responsive to the authentication indicium.

14. An apparatus as in claim 13 which includes second processing software to combine at least some of the information with a quality indicator to produce a second authentication indicium.

15. An apparatus as in claim 14 which includes software that process the first and second indicia to produce an output that is coupled to the output device.

16. An apparatus as in claim 15 where the output device produces an accept indicator.

17. An apparatus as in claim 15 which includes a processor programmable with at least some of the software.

18. An apparatus as in claim 13 where the first type of biometric comprises at least one of a fingerprint sensor, an iris scanner, a retinal scanner, a facial scanner, a palm sensor or an ear scanner.

19. An apparatus as in claim 13 which includes second data acquisition software that obtains second information associated with a second type of biometric.

20. An apparatus as in claim 19 which includes software to provide a second biometric quality indicium.

21. An apparatus as in claim 20 which includes additional processing software to combine at least part of the second information with the second quality indicium to produce a second authentication indicium and, output producing software that combines the authentication indicia to form a composite authenticating output.

22. A system comprising:
first and second sensors of at least one of physical, physiological or behavioral characteristics of an individual, each of the sensors produces respective sensed characteristic information;
first software that makes a determination in response to respective sensed characteristic information, from each sensor, as to an individual associated with such characteristic information and provides respective second data as to each determination;
second software that makes a respective quality determination relative to sensed characteristic information from each sensor;
third software which combines data as to each determination, including quality data, associated with each sensor, to form composite authentication indicia.

23. A system as in claim 22 where the first software includes different recognition software associated with a respective sensor.

24. A system as in claim 22 where the second software makes an independent quality determination as to each respective type of information.

25. A system as in claim 22 which includes a database of characteristics of at least one individual.
